(19) United States
(12) Patent Application Publication
(10) Pub. No.: US 2013/0007866 A1
(43) Pub. Date: Jan. 3, 2013

(54) MIGRATION ACROSS AUTHENTICATION SYSTEMS

(75) Inventor: Jeffery L. Crume, Raleigh, NC (US)

(73) Assignee: INTERNATIONAL BUSINESS MACHINES CORPORATION, Armonk, NY (US)

(21) Appl. No.: 13/612,949

(22) Filed: Sep. 13, 2012

Related U.S. Application Data
(63) Continuation of application No. 12/426,365, filed on Apr. 20, 2009.

(51) Int. Cl. G06F 21/00

(52) U.S. Cl. 726/7

(57) ABSTRACT

A system, method, program product and a method for deploying a system for providing migration across authentication systems are disclosed. A system is provided that includes a login system that collects information from a user during a login process, a migration list check system that compares the information to a migration list to determine if the user is selected for migration, and a migration logic system that migrates the user from the existing authentication system to the new authentication system during the login process if the user is selected.

### RELATED APPLICATIONS

The current application is a continuation application of U.S. application Ser. No. No. 12/426,365, filed on Apr. 20, 2009, which is hereby incorporated by reference

### FIELD OF THE INVENTION

This disclosure relates to the migration of users across authentication systems, and more specifically discloses a system, method, program product and a method for deploying a system for the selective, secure and transparent migration of users across authentication systems.

### RELATED ART

Authentication systems are widely used by websites to authenticate a user. For example, an authentication system may be used to provide access to a secure resource. A secure resource may, for example, include: customer data, financial information or retirement accounts. Occasionally, websites may also implement new authentication systems to, for example, upgrade security, replace legacy systems and provide additional services to their customers. The migration of users from one authentication system to another introduces certain challenges. As an example, users are typically required to change their password or re-register because credentials are not typically transferable. In addition, there may be a desire to have a phased migration when a new authentication system is introduced. A phased migration allows for the conservation of resources, the ability to monitor the migration in a controlled environment, the ability to stop, increase or decrease the migration and the ability to select the number, or group, of users to be migrated.

In a typical migration, a user logs into an existing authentication system and is directed to a new authentication system. The user then typically has to login again or provide supplemental information before reaching the new authentication system. The additional information required from the user, as an example, may be in the form of re-entering a user identification and password, creating a new password, or providing some other information to confirm the authenticity of the user.

The additional time and effort required by the user for entering this information or the need to provide and then remember a new user identification and password is often an inconvenience and a barrier to a user attempting to reach a new authentication system.

### SUMMARY OF THE INVENTION

A system, method, program product and a method for deploying a system for providing migration across authentication systems are disclosed. In one embodiment, there is a migration system that includes a login system that collects information from a user, a migration list check system that compares the user to a migration list to determine if the user is selected for migration and a migration logic system that migrates the user from the existing authentication system to the new authentication system during the login process if the user is selected.

In a second embodiment, there is a computer readable medium having a program product stored therein for migrating a user from an existing authentication system to a new authentication system, comprising program code for collecting information from the user during a login process, program code for comparing the information to a migration list to determine if the user is selected for migration, and program code for migrating the user from the existing authentication system to the new authentication system during the login process if the user is selected.

In a third embodiment, there is a method of migrating a user from an existing authentication system to a new authentication system, comprising collecting information from the user during a login process, comparing the information to a migration list to determine if the user is selected for migration, and migrating the user from the existing authentication system to the new authentication system during the login process if the user is selected.

In a fourth embodiment, there is a method for deploying a system for migrating a user from an existing authentication system to a new authentication system, comprising providing a computer infrastructure being operable to collect information from a user during the login process, compare the information to a migration list to determine if the user is selected for migration and migrate the user transparently from the existing authentication system to the new authentication system.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer system having a migration system in accordance with an embodiment of the present invention.

FIG. 2 illustrates an example of a migration list.

FIG. 3 depicts a flow diagram of embodiments of a method of using the system of FIG. 1.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

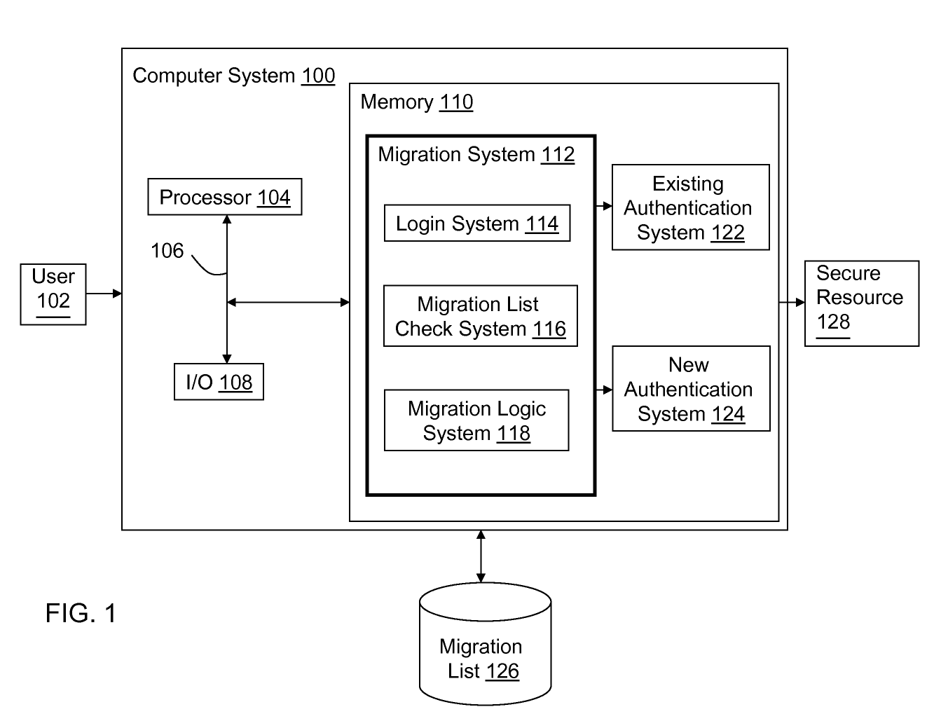

Referring to FIG. 1, a computer system 100 for migrating users from an existing authentication system 122 to a new authentication system 124 is shown, and generally includes a processor 104, a bus 106, an input/output (I/O) 108 and a memory 110. Stored in memory 110 is a migration system 112 that includes a login system 114 that collects credential information from a user 102 (e.g., user identification and password) to allow access to secure resource 128, a migration list check system 116 that compares the information of user 102 to a migration list 126, and a migration logic system 118 that migrates user 102 from the existing authentication system 122 to the new authentication system 124 (if selected). Secure resource 128 may include, as an example, a bank account, retirement account or history of mortgage payments. In one embodiment, user 102 may be able to access one or more secure resources 128 through new authentication system 124.

Login system 114 may comprise any system for collecting user credentials to authenticate user 102. For example, login system 114 may collect a user identification, password, voice recognition, or biometric data such as fingerprints, retinal scans, etc.

Migration list check system 116 utilizes migration list 126 to identify the users to be migrated from existing authentication system 122 to new authentication system 124. Initially, user 102 enters their credentials into login system 114. Login system 114 then checks for the existence of user 102 in new authentication system 124. If user 102 is in new authentication system 124, then login system 114 logs user 102 in new authentication system 124. If user 102 is not in new authentication system 124, then migration list check system 116 checks migration list 126 to determine if user 102 has been selected for migration. If user 102 is not selected for migration, migration list check system 116 causes user 102 to be logged in using existing authentication system 122. If user 102 is selected for migration, then migration logic system 118 migrates user 102 from existing authentication system 122 to new authentication system 124 as part of the login process.

Migration system 112 may migrate user 102 selectively from existing authentication system 122 to new authentication system 124 to, for example, allow for a phased migration. In an illustrative embodiment, migration list 126 contains a list of users that have been selected for migration. The selection of the users for migration may be based on any number of criteria. For example, the users selected for migration may be determined on a specific class of users, on frequency of use of the secure resource 128, or the size of the user's account, to name a few. In selecting users for migration, migration system 112 may use one of these or another criterion. Migration system 112 migrates user 102 from existing authentication system 122 to new authentication system 124 at the next time user 102 logs into login system 114 after being “selected” (i.e., selected for migration in migration list 126).

The phased migration of users may result in a conservation of resources for computer system 100 as the migration occurs over time compared to the migration occurring all at once. Additionally, the phased migration may allow for the migration's progression to be observed and, if necessary, for changes to be made during the migration. Phased migration may also allow for changing during migration which users are to be migrated, the speed of migration and if an additional new secure resource 128 should be included or one removed.

In one embodiment, migration logic system 118 can perform the migration using a web authentication system. In an alternative embodiment, the migration can be architected to run in any environment where migration across authentication systems is needed. When migration utilizes a web authentication system, a migration website may be installed between existing authentication system 122 and user 102. This can be done, for example, by changing the domain name system (DNS) address of the authentication domain to point to the migration server.

When a user is selected for migration, migration logic system 118 captures a user's password during login and automatically stores the password in new authentication system 124 upon a successful authentication in existing authentication system 122. In another embodiment, the expiration date of user's password is also migrated from existing authentication system 122 to new authentication system 124. The migration of user 102 from existing authentication system 122 to new authentication system 124 may be transparent to user 102. Thus, user 102, when being migrated from existing authentication system 122 to new authentication system 124, will not know they are being migrated.

It is understood that computer system 100 may be implemented as any type of computing infrastructure. The processor 104 may comprise a single processing unit, or be distributed across one or more processing units in one or more locations (e.g., on a client and server). Memory 110 may comprise any known type of data storage, including magnetic media, optical media, random access memory (RAM), read-only memory (ROM), a data cache, a data object, etc. Moreover, memory 110 may reside at a single physical location, comprising one or more types of data storage, or be distributed across a plurality of physical systems in various forms.

I/O 108 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 106 provides a communication link between each of the components in computer system 100 and likewise may comprise any known type of transmission link, including electrical, optical, wireless, etc. Although not shown, additional components, such as cache memory, communication systems, system software, etc., may be incorporated into computer system 100.

Access to computer system 100 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

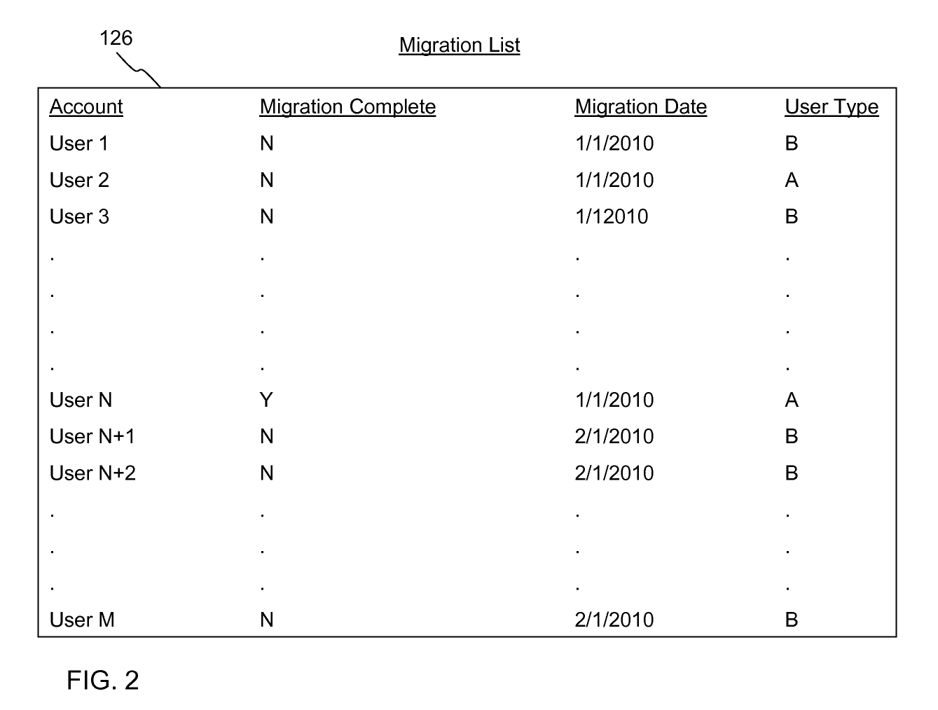

FIG. 2 illustrates a simple example of a migration list 126. In this case, migration list 126 may include a list of all the users and the status of their migration (i.e., migration complete or migration not complete). Additionally, migration list 126 may include a date after which a user is to be migrated. For instance, migration list 126 may have a group of users set for migration after January 1st. The next time the users login after the pre-determined date (in this case, January 1st), the user will be migrated. Migration list 126 may include additional information regarding each user. For example, migration list 126 may include a user type, list the secure resource 128 (FIG. 1) that is associated with user and provide the last time the user logged into the secure resource. The user type may also be used by the migration system to determine when users are to be selectively migrated.

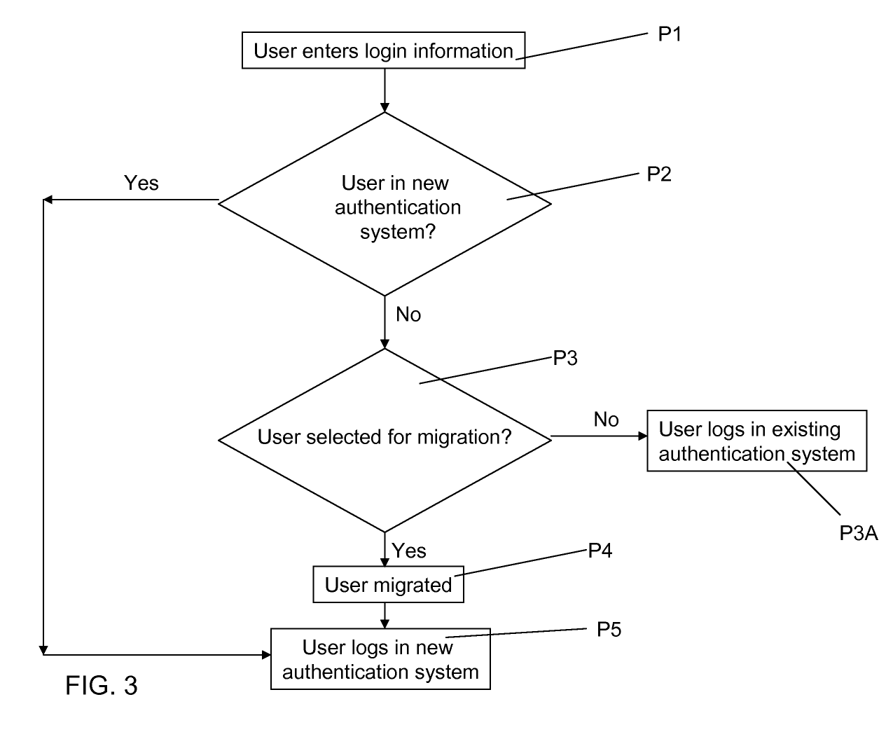

FIG. 3 shows a flow diagram illustrating one embodiment of the process of migration system 112 (with reference to FIG. 1). In process P1, user 102 enters their login information. In process P2, login system 114 checks for the existence of user 102 in new authentication system 124. If user 102 is in new authentication system 124 (i.e., YES at P2), then login system 114 logs user 102 in new authentication system 124 (P5). If user 102 is not in new authentication system 124 (i.e., NO at process P2), then migration list check system 116 checks if user 102 has been selected for migration (P3). Migration list check system 116 checks if user 102 is selected for migration by comparing user 102 to migration list 126. If user 102 is not selected for migration (i.e., NO at process P3), then user 102 logs into existing authentication system 122, process P3A. If user 102 is selected for migration (i.e., YES at process P3), then in process P4 the user is migrated from existing authentication system 122 to new authentication system 124 using migration logic system 118. In process P5, user 102 logs into and is authenticated by new authentication system 124. Once user 102 is migrated from existing authentication system 122 to new authentication system 124, migration list 126 is updated to indicate that user 102 was migrated to new authentication system 124.

It should be appreciated that the teachings of the present invention could be offered as a business method on a subscription or fee basis. For example, a computer system 100 including memory 110 with migration system 112 could be created, maintained and/or deployed by a service provider that offers the functions described herein for customers. That is, a service provider could offer to deploy or provide a migration system 112 as described above.

It is understood that in addition to being implemented as a system and method, the features may be provided as a program product stored on a computer-readable medium, which when executed, enables computer system 100 to provide a migration system 112. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 110 and/or a storage system.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A system for migrating a user from an existing authentication system to a new authentication system, comprising:
a login system that collects information from the user during a login process;
a migration list check system that compares the information to a migration list to determine if the user is selected for migration; and
a migration logic system that migrates the user from the existing authentication system to the new authentication system during the login process if the user is selected.

2. The system of claim 1, wherein the migration list identifies a set of users to be migrated.

3. The system of claim 1, wherein the migration system migrates the user selectively from the existing authentication system to the new authentication system.

4. The system of claim 1, wherein the migration system migrates the user from the existing authentication system to the new authentication system a first time the user logs in after being selected.

5. The system of claim 1, wherein a password is captured during the login process and automatically stored in the new authentication system when the user is migrated.

6. The system of claim 5, wherein an expiration of the password is migrated from the existing authentication system to the new authentication system.

7. The system of claim 1, wherein the migration of the user from the existing authentication system to the new authentication system is transparent to the user.

8. A computer readable storage medium having a program product stored therein for migrating a user from an existing authentication system to a new authentication system when executed by a computing system, comprising program code for:
collecting information from the user during a login process;
comparing the information to a migration list to determine if the user is selected for migration; and
migrating the user from the existing authentication system to the new authentication system during the login process if the user is selected.

9. The computer readable medium of claim 8, wherein the migration list identifies a set of users to be migrated.

10. The computer readable medium of claim 8, further comprising program code for migrating the user selectively from the existing authentication system to the new authentication system.

11. The computer readable medium of claim 8, further comprising program code for migrating the user from the existing authentication system to the new authentication system a first time the user logs in after being selected.

12. The computer readable medium of claim 8, further comprising program code for capturing a password during the login process and automatically storing the password in the new authentication system when the user is migrated.

13. The computer readable medium of claim 12, further comprising program code for migrating the expiration date of the password from the existing authentication system to the new authentication system.

14. The computer readable medium of claim 8, wherein the migration of the user from the existing authentication system to the new authentication system is transparent to the user.

15. A method of migrating a user from an existing authentication system to a new authentication system, comprising:
collecting information from the user during a login process of a computer system;
comparing the information to a migration list to determine if the user is selected for migration; and
migrating the user from the existing authentication system to the new authentication system during the login process if the user is selected.

16. The method of claim 15, wherein the migration list identifies a set of users to be migrated.

17. The method of claim 15, wherein the migration of the user occurs selectively from the existing authentication system to the new authentication system.

18. The method of claim 15, wherein the migration of the user from the existing authentication system to the new authentication system occurs a first time the user logs in after being selected.

19. The method of claim 15, wherein a password is captured during the login process and automatically stored in the new authentication system when the user is migrated.

20. A method for deploying a system for migrating a user from an existing authentication system to a new authentication system, comprising:
providing a computer infrastructure being operable to:
collect information from a user during a login process;
compare the information to a migration list to determine if the user is selected for migration;
select the user for migration from the existing authentication system to the new authentication system; and
migrate the user transparently from the existing authentication system to the new authentication system.
